(19) United States
(12) Patent Application Publication
(10) Pub. No.: US 2023/0117238 A1
(43) Pub. Date: Apr. 20, 2023

(54) METHOD FOR SEGMENTING NEURAL NETWORK, ELECTRONIC DEVICE, AND STORAGE MEDIUM

(71) Applicant: HON HAI PRECISION INDUSTRY CO., LTD., New Taipei (TW)

(72) Inventor: CHIEN-WU YEN, New Taipei (TW)

(21) Appl. No.: 17/969,804

(22) Filed: Oct. 20, 2022

(30) Foreign Application Priority Data
Oct. 20, 2021 (CN) 202111221617.2

(51) Int. Cl. G06N 3/04; G06N 3/063; G06F 11/34

(52) U.S. Cl. CPC G06N 3/04; G06N 3/063; G06F 11/3419

(57) ABSTRACT

A method for segmenting a neural network, implemented in an electronic device, includes assigning a plurality of operator groups to a plurality of execution units based on a plurality of segmentation methods; determining operation times of the plurality of execution units and discrete degree of the operation times of the plurality of execution units in each of the plurality of segmentation methods; and segmenting the neural network according to the segmentation method with a lowest discrete degree.

### FIELD

The subject matter herein generally relates to machine learning, and particularly to an electronic device, a method for segmenting a neural network, and a storage medium.

### BACKGROUND

Artificial Neural Networks (ANNs), also referred to as Neural Networks (NNs), is an algorithmic mathematical model that imitates behavioral characteristics of animal neural networks and performs a distributed parallel information process. The neural network can be divided into a number of operator groups and assigned to execution units, processors, or accelerators, etc. to perform preset operations or achieve load balancing.

In some scenarios, after the neural network is divided and a number of operator groups are assigned to operators with the same function, when the a number of operators completes the operation, the a number of operators can execute the instructions in the next step synchronously. Due to different operation times or practices of each operator group, the difference in the operation time of a number of operators is difficult to control, an operator that completes the operation first is required to wait for the last operator that completes the operation before continuing to perform other operations, and the work efficiency is low.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a flowchart of an embodiment of a method for segmenting a neural network according to the present disclosure.

FIG. 2 is a schematic view of an embodiment of operators and sub-operators of a neural network according to the present disclosure.

FIG. 3 is a schematic view of an embodiment of operator groups in a neural network according to the present disclosure.

FIG. 4 illustrates a flowchart of another embodiment of a method for segmenting a neural network according to the present disclosure.

FIG. 5 is a block diagram of an embodiment of a segmentation system of neural network according to the present disclosure.

FIG. 6 is a block diagram of an embodiment of an electronic device according to the present disclosure.

### DETAILED DESCRIPTION

A number of embodiments are described in the present disclosure, but the description is exemplary rather than limiting, and there may be more embodiments and implementation solutions within the scope of the embodiments described in the present disclosure. Although many possible combinations of features are shown in the drawings and discussed in the detailed description, many other combinations of the disclosed features are also possible. Unless specifically limited, any feature or element of any embodiment may be used in combination with or in place of any other feature or element of any other embodiment.

When describing representative embodiments, the specification may present methods and/or processes as a specific sequence of steps. However, to the extent that the method or process does not depend on the specific order of steps described in the present disclosure, the method or process should not be limited to the specific order of steps described. As understood by those of ordinary skills in the art, other orders of steps are also possible. Therefore, the specific order of steps set forth in the specification should not be interpreted as limitation to the claims. In addition, the claims for the method and/or process should not be limited to the steps performed in the written order, and those of skill in the art may readily understand that these orders may vary and still remain within the essence and scope of the embodiments of the present disclosure.

Unless otherwise defined, technical terms or scientific terms used in the embodiments shall have common meanings as construed by those of ordinary skills in the art to which the present disclosure pertains. The terms “first”, “second” and the like used in the embodiments of the present disclosure do not represent any order, quantity, or importance, but are merely used to distinguish between different components. The terms “include”, “contain” or the like mean that elements or articles covered by such terms do not exclude their equivalents or other elements or articles. The terms “connect”, “link” or the like are not limited to physical or mechanical connection, but may include electrical connections, whether direct or indirect.

In some scenarios, a neural network is required to be segmented into a number of operator groups, each operator group is assigned to an execution unit, a processor, or other accelerators, to perform data calculation and load balancing, etc. When the neural network is segmented and a number of operator groups are assigned to multiple execution units with the same function, the operation time of each operator group is different, it is difficult to control the operation time of the multiple execution units, which affects the work efficiency.

In order to reduce the difference between the operation time of each execution unit and improve the work efficiency, a method for segmenting a neural network is provided.

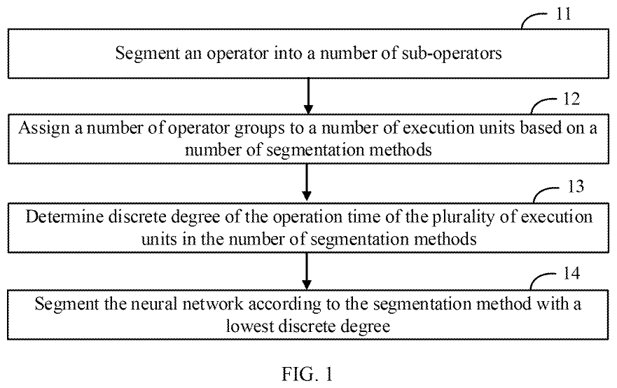

FIG. 1 illustrates a flowchart of an embodiment of the method for segmenting a neural network. The method is provided by way of example, as there are a variety of ways to carry out the method. Each block shown in FIG. 1 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 11.

At block 11, segmenting an operator into a number of sub-operators.

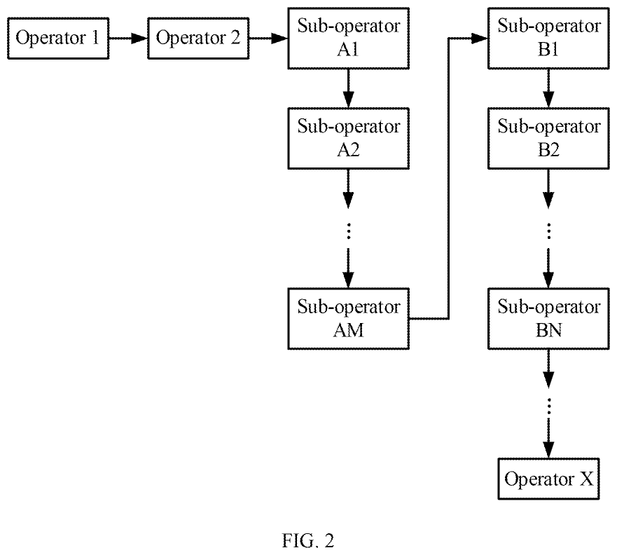

Referring to FIG. 2, in one embodiment, a neural network includes a number of operators connected in a first preset order, such as an operator 1, an operator 2, etc., each operator may be a step of an algorithm run by the neural network; the operator can be segmented into a number of sub-operators connected in a second preset order, such as a sub-operator A1, a sub-operator A2, etc., each sub-operator can be a sub-step of a step in an algorithm.

It can be understood that during the establishment of the neural network, each operator is formed of a plurality of sub-operators, and each operator may include a preset number of sub-operators with preset characteristics, that is, the preset number and preset characteristics of the sub-operators have been determined when the neural network is established; in the process of segmenting the operator into a number of sub-operators, it is not necessary to manually adjust the number of the sub-operators and determine the segmentation position of the operator.

In one embodiment, an operation time of the operator and the sub-operator is known and fixed.

At block 12, assigning a number of operator groups to a number of execution units based on a number of segmentation methods.

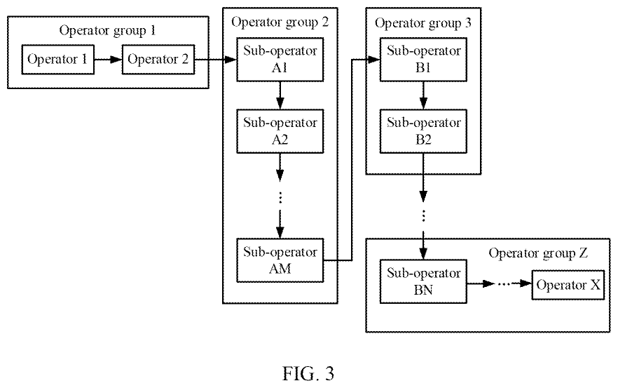

Referring to FIG. 3, in one embodiment, the operators and the sub-operators in the neural network may be assigned to a plurality of operator groups, such as an operator group 1, an operator group 2, etc. In each operator group, the number of operators may be one or more, and the number of sub-operators may be one or more, which is not limited in the embodiments.

In one embodiment, the segmentation method includes: assigning designated operators and designated sub-operators in the neural network to a designated operator group, and assigning a plurality of designated operator groups to a designated execution unit. In different segmentation methods, the operator groups assigned to a same execution unit may be different, that is, the number of operators and the number of sub-operators in different operator groups are different, the operators and the sub-operators in different operator groups are different, or the number of the operator groups assigned to the execution unit is different. In one embodiment, the execution unit can be a processor or a central processing unit (CPU).

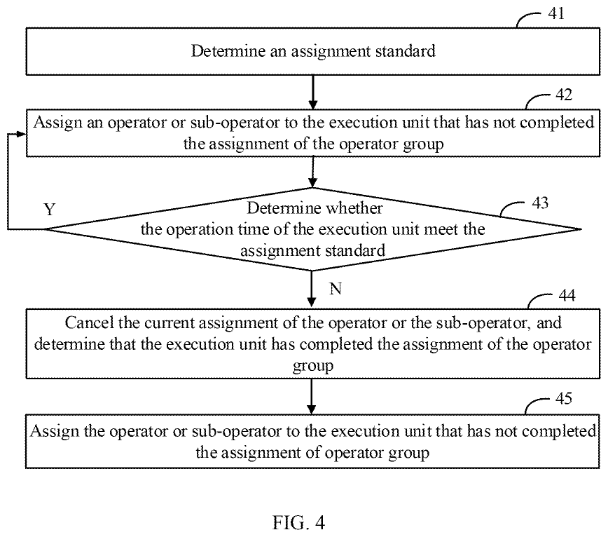

Referring to FIG. 4, in one embodiment, assigning a number of operator groups to a number of execution units includes:

At block 41, determining an assignment standard according to the operation time of a number of operators and a number of sub-operators.

It can be understood that the assignment standard is a judgement standard for determining whether to continue to assign a next operator or sub-operator during the process of assigning the operator group to the execution unit. When the operation time of the execution unit meets the assignment standard, it is determined to continue to assign the next operator or sub-operator; when the operation time of the execution unit does not meet the assignment standard, it is determined to stop assigning the current operator or sub-operator, and determined that a plurality of operators and/or sub-operators which have been assigned form the operator group corresponding to the execution unit.

At block 42, assigning an operator or sub-operator to the execution unit that has not completed the assignment of the operator group.

In one embodiment, an arrangement order of the operators and the sub-operators is fixed, the sub-operators and the operators are sequentially assigned to one of the execution units according to the arrangement order of the operators and sub-operators.

At block 43, determining whether the operation time of the execution unit meets the assignment standard; if the operation time of the execution unit meets the assignment standard, the process goes back to block 42, if the operation time of the execution unit does not meet the assignment standard, the process goes to block 44.

In one embodiment, the assignment standard includes: the operation time of the execution unit and a first threshold satisfying a preset numerical relationship. The first threshold may be a preset value.

In one embodiment, the preset numerical relationship between the operation time of the execution unit and the first threshold includes the operation time of the execution unit and the first threshold satisfying a preset functional relationship, or the operation time of the execution unit is greater than, or less than, or equal to, the first threshold.

For example, the first threshold may be an average operation time, and the average operation time can be an average operation time of a plurality of execution units. In one embodiment, the average operation time TE is calculated according to the following formula (1):

TE=T/N (1)

In the formula (1), T represents a total operation time of the operators and the sub-operators, and N represents the number of the execution units.

In one embodiment, when the current operation time of the execution unit is equal to or less than the average operation time, it is determined that the operation time of the execution unit meets the assignment standard; if the current operation time of the execution unit is greater than the average operation time, it is determined that the operation time of the execution unit does not meet the assignment standard.

In one embodiment, the operation time of the execution unit is equal to a sum of the operation time of the operators and the sub-operators assigned to the execution unit.

It can be understood that the operation time of the execution unit is required to be less than or equal to the average operation time, that is, the first threshold, so that the operation time of each execution unit can be controlled to be within a certain value, the discreteness of the operation time of each execution unit is reduced, so that the operation time of each of the plurality of execution units is close.

It can be understood that, when the operation time of the execution unit is less than or equal to the average operation time, in order to avoid wasting the operation capability of the execution unit, the process goes back to block 42, the operator or the sub-operator is continued to be assigned to the execution unit, and whether the operation time of the execution unit meets the assignment standard is determined again.

It can be understood that when the current operation time of the execution unit being less than or equal to the average operation time is taken as the assignment standard, the calculation of the average operation time according to the operation time of a plurality of operators, the operation time of a plurality of sub-operators, and the number of execution units is implemented in block 41.

At block 44, cancelling the current assignment of the operator or the sub-operator, and determining that the execution unit has completed the assignment of the operator group, and the process goes to block 45.

In one embodiment, when the operation time of the execution unit is greater than the average operation time, the difference between the operation time of the execution unit and the operation time of the other execution unit is large, and the last assignment of the operator or sub-operator for the execution unit is required to be cancelled.

It can be understood that when the execution unit has completed the assignment of the operator group, the operation time of the execution unit is less than or equal to the average operation time, and the sum of the operation time of the execution unit and the operation time of next operator or sub-operator to be assigned is greater than the average operation time.

At block 45, assigning the operator or sub-operator to the execution unit that has not completed the assignment of operator group.

In one embodiment, after one execution unit has completed the assignment of the operator group, one of the execution units that remains unassigned can be re-selected from the remaining execution units, the assignment of the operator or the sub-operator is performed, that is, another execution unit that is unassigned with the operator group is selected, block 42 is executed.

At block 13, determining discrete degree of the operation time of the plurality of execution units in the number of segmentation methods.

It can be understood that the lower the discrete degree of the operation time of the plurality of execution units, the less is the difference in operation time of the plurality of execution units. Therefore, a number of segmentation methods are applied to implement the assignment of the operator group for the execution unit, and a segmentation method that minimizes the discrete degree of the operation time of the execution unit is determined and selected.

In one embodiment, the discrete degree of the operation time of the plurality of execution units in a number of segmentation method is determined by calculating a standard deviation of the operation time of the plurality of execution units. It can be understood that the standard deviation is a value used to statistically represent the discrete degree in a statistical operation, and the value of the standard deviation is proportional to the discrete degree of the operation time of the execution units, that is, the smaller the value of the standard deviation, the lower is the discrete degree of the operation time of the execution units, that is, there will be an increased closeness of the operation time of the execution unit.

In one embodiment, the standard deviation SD is calculated according the following formula (2):

$$SD = \sqrt{\frac{1}{N} {{\sum }^{N}}_{i = 1} {( {x}_{i} - μ )}^{2}} \qquad ( 2 )$$

In the formula (2), p represents the average operation time, x, represents the operation time of each the execution unit, and N represents the number of the execution units.

At block 14, segmenting the neural network according to the segmentation method with the lowest discrete degree.

It can be understood that the segmentation method with the lowest discrete degree is the optimal scheme, when the operation time of each execution unit is close to each other in the segmentation method, then the segmentation method is selected to determine the operator group assigned to the execution unit, so as to improve segmentation efficiency.

In a possible scenario, whether or not the standard deviation is the smallest standard deviation may be determined by calculating and comparing the standard deviations corresponding to all the segmentation methods.

In another possible scenario, whether the standard deviation is the smallest standard deviation may be determined by calculating the standard deviations corresponding to the plurality of segmentation methods, and after the standard deviations are calculated, each standard deviation is compared with a second threshold, to determine whether a standard deviation is less than the second threshold. If no standard deviation is less than the second threshold, then all the standard deviations is obtained and compared with the second threshold.

It can be understood that in the possible scenario, the second threshold may be a value preset according to experiments or experience, when the standard deviation is less than the second threshold, it can be determined that the closeness degree of the operating times of different execution units in the segmentation method is high enough to meet the requirement. Therefore, after calculating the standard deviations corresponding to the plurality of segmentation methods one by one, and comparing each of the standard deviations with the second threshold, if a standard deviation is less than the second threshold, the calculation of the standard deviation can be stopped, and the standard deviation can be determined as the minimum standard deviation, and the segmentation method corresponding to the standard deviation can be determined as the optimal scheme.

It can be understood that, in the possible scenario, if no standard deviation is less than the second threshold, a plurality of standard deviations can be sorted and compared, the standard deviation with the smallest value is determined, and it is determined that the segmentation method corresponding to the smallest standard deviation is determined to be the optimal method.

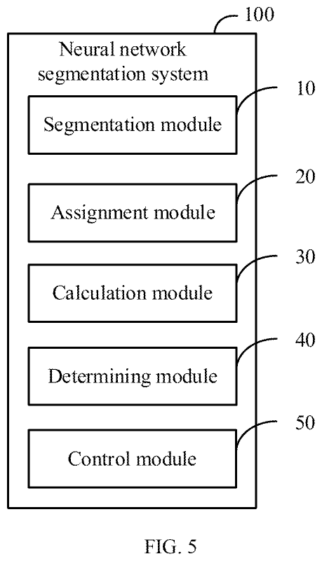

Referring to FIG. 5, a neural network segmentation system 100 includes a segmentation module 10, an assignment module 20, a calculation module 30, a determining module 40, and a control module 50. The modules 10-50 can be collections of software instructions stored in the storage device 70 of the electronic device 200 and executed by the processor 60. The modules 10-50 also can include functionality represented by hardware or integrated circuits, or by software and hardware combinations, such as a special-purpose processor or a general-purpose processor with special-purpose firmware.

The segmentation module 10 is configured to segment the operator into a plurality of sub-operators.

In one embodiment, the number of operator to be segmented can be one or more, which is not limited.

The assignment module 20 is configured to assign a plurality of operator groups to a plurality of the execution units.

It can be understood that the operators assigned to each of the execution units and the sub-operators form the operator group assigned to the execution unit.

The calculation module 30 is configured to calculate an operating time of each execution unit, and is further configured to calculate a standard deviation of the operating time of each execution unit, and determine discrete degree of the operating time of execution units.

The determining module 40 is configured to determine a segmentation method with the lowest discrete degree.

The control module 50 is configured to segment the neural network according to the segmentation method with the lowest discrete degree.

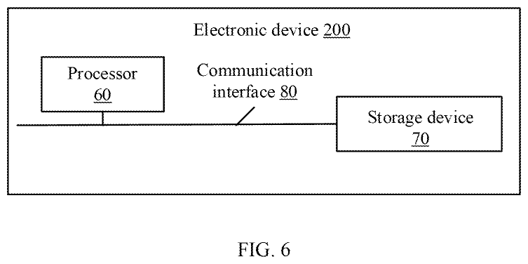

FIG. 6 illustrates an electronic device 200 in one embodiment. The electronic device 200 includes, but is not limited to, the neural network segmentation system 100, a processor 60, a storage device 70, a communication interface 80, and a computer program. FIG. 6 illustrates only one example of the electronic device 200. Other examples can include more or fewer components than as illustrated or have a different configuration of the various components in other embodiments.

The processor 60 can be a central processing unit (CPU), a microprocessor, or other data processor chip that performs functions in the electronic device 200.

In one embodiment, the storage device 70 can include various types of non-transitory computer-readable storage mediums. For example, the storage device 70 can be an internal storage system, such as a flash memory, a random access memory (RAM) for the temporary storage of information, and/or a read-only memory (ROM) for permanent storage of information. The storage device 70 can also be an external storage system, such as a hard disk, a storage card, or a data storage medium. The processor 60, the storage device 70, and the communication interface 80 can be connected and communicate with each other through a communication bus. The communication interface 80 communicates with other devices or communication networks, such as Ethernet, radio access network (RAN), Wireless Local Area Networks (WLAN), etc.

The storage device 70 stores instructions, and the processor 60 executes the computer program 30 stored in the storage device 70 for implementing the method for segmenting a neural network provided in the embodiments of the present disclosure. The computer program is a neural network segmentation program and includes instructions.

Upon execution of the instructions stores in the storage device 70, the processor 60 is configured to:

segment an operator into a number of sub-operators;

assign a number of operator groups to a number of execution units based on a number of segmentation methods;

determine discrete degree of the operation time of the plurality of execution units in the number of segmentation methods;

segment the neural network according to the segmentation method with the lowest discrete degree.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A method for segmenting a neural network implemented in an electronic device comprising:
assigning a plurality of operator groups to a plurality of execution units based on a plurality of segmentation methods;
determining operation times of the plurality of execution units and discrete degree of the operation times of the plurality of execution units in each of the plurality of segmentation methods; and
segmenting the neural network according to the segmentation method with a lowest discrete degree.

2. The method according to claim 1, further comprising:
segmenting each of a plurality of operators into a plurality of sub-operators, the operator group comprising the operators and the sub-operators.

3. The method according to claim 2, wherein assigning a plurality of operator groups to a plurality of execution units based on a plurality of segmentation methods comprises:
assigning an operator or sub-operator to the execution unit that has not completed assignment of the operator group;
determining whether an operation time of the execution unit meets an assignment standard;
in response that the operation time of the execution unit meets the assignment standard, assigning a next operator or sub-operator to the execution unit; and
in response that the operation time of the execution unit does not meet the assignment standard, cancelling assignment of the operator or the sub-operator, and assigning the operator or the sub-operator to the execution unit that has not completed the assignment of operator group.

4. The method according to claim 3, wherein the operator and the sub-operator both have the operation time, assigning a plurality of operator groups to a plurality of execution units based on a plurality of segmentation methods further comprises:
calculating an average operation time of the plurality of execution units according to the operation time of the plurality of operators and the plurality of sub-operators, and a number of execution units.

5. The method according to claim 4, wherein determining whether an operation time of the execution unit meets an assignment standard comprises:
determining whether the operation time of the execution unit is less than the average operation time;
in response that the operation time of the execution unit is less than the average operation time, determining that the operation time of the execution unit meets the assignment standard; and
in response that the operation time of the execution unit is greater than or equal to the average operation time, determining that the operation time of the execution unit does not meet the assignment standard.

6. The method according to claim 4, wherein determining operation times of the plurality of execution units and discrete degree of the operation times of the plurality of execution units in each of the plurality of segmentation methods comprises:
calculating a standard deviation of the operation times of the plurality of execution units according to the operation times of the plurality of execution unit and the average operation time; and
determining the discrete degree according to the standard deviation, the standard deviation being proportional to the discrete degree of the operation times of the plurality of execution units.

7. The method according to claim 6, wherein segmenting the neural network according to the segmentation method with a lowest discrete degree comprises:
determining a smallest standard deviation in a plurality of standard deviations; and
segmenting the neural network according to the segmentation method with the smallest standard deviation.

8. An electronic device comprising:
at least one processor; and
a storage device coupled to the at least one processor and storing instructions for execution by the at least one processor to cause the at least one processor to:
assign a plurality of operator groups to a plurality of execution units based on a plurality of segmentation methods;
determine operation times of the plurality of execution units and discrete degree of the operation times of the plurality of execution units in each of the plurality of segmentation methods; and
segment the neural network according to the segmentation method with a lowest discrete degree.

9. The electronic device according to claim 8, wherein the at least one processor is further caused to:
segment each of a plurality of operators into a plurality of sub-operators, the operator group comprising the operators and the sub-operators.

10. The electronic device according to claim 9, wherein the at least one processor is further caused to:
assign an operator or sub-operator to the execution unit that has not completed assignment of the operator group;
determine whether an operation time of the execution unit meets an assignment standard;
in response that the operation time of the execution unit meets the assignment standard, assign a next operator or sub-operator to the execution unit; and
in response that the operation time of the execution unit does not meet the assignment standard, cancelling assignment of the operator or the sub-operator, and assign the operator or the sub-operator to the execution unit that has not completed the assignment of operator group.

11. The electronic device according to claim 10, wherein the at least one processor is further caused to:
calculate an average operation time of the plurality of execution units according to the operation time of the plurality of operators and the plurality of sub-operators, and a number of execution units.

12. The electronic device according to claim 11, wherein the at least one processor is further caused to:
determine whether the operation time of the execution unit is less than the average operation time;
in response that the operation time of the execution unit is less than the average operation time, determine that operation time of the execution unit does not meet the assignment standard; and
in response that the operation time of the execution unit is greater than or equal to the average operation time, determine that the operation time of the execution unit meets the assignment standard.

13. The electronic device according to claim 11, wherein the at least one processor is further caused to:
calculate a standard deviation of the operation times of the plurality of execution units according to the operation times of the plurality of execution unit and the average operation time; and
determine the discrete degree according to the standard deviation, the standard deviation being proportional to the discrete degree of the operation times of the plurality of execution units.

14. The electronic device according to claim 13, wherein the at least one processor is further caused to:
determine a smallest standard deviation in a plurality of standard deviations; and
segmenting the neural network according to the segmentation method with the smallest standard deviation.

15. A computer-readable storage medium having instructions stored thereon, when the instructions are executed by a processor of an electronic device, the processor is configured to perform a method for segmenting a neural network, wherein the method comprises:
assigning a plurality of operator groups to a plurality of execution units based on a plurality of segmentation methods;
determining operation times of the plurality of execution units and discrete degree of the operation times of the plurality of execution units in each of the plurality of segmentation methods; and
segmenting the neural network according to the segmentation method with a lowest discrete degree.

16. The storage medium according to claim 15, wherein the method further comprises:
segmenting each of a plurality of operators into a plurality of sub-operators, the operator group comprising the operators and the sub-operators.

17. The storage medium according to claim 16, wherein assigning a plurality of operator groups to a plurality of execution units based on a plurality of segmentation methods comprises:
assigning an operator or sub-operator to the execution unit that has not completed assignment of the operator group;
determining whether an operation time of the execution unit meets an assignment standard;
in response that the operation time of the execution unit meets the assignment standard, assigning a next operator or sub-operator to the execution unit; and
in response that the operation time of the execution unit does not meet the assignment standard, cancelling assignment of the operator or the sub-operator, and assigning the operator or the sub-operator to the execution unit that has not completed the assignment of operator group.

18. The storage medium according to claim 17, wherein the operator and the sub-operator both have the operation time, assigning a plurality of operator groups to a plurality of execution units based on a plurality of segmentation methods further comprises:
calculating an average operation time of the plurality of execution units according to the operation time of the plurality of operators and the plurality of sub-operators, and a number of execution units.

19. The storage medium according to claim 18, wherein determining whether an operation time of the execution unit meets an assignment standard comprises:
determining whether the operation time of the execution unit is less than the average operation time;
in response that the operation time of the execution unit is less than the average operation time, determining that the operation time of the execution unit meets the assignment standard; and
in response that the operation time of the execution unit is greater than or equal to the average operation time, determining that the operation time of the execution unit does not meet the assignment standard.

20. The storage medium according to claim 18, wherein determining operation times of the plurality of execution units and discrete degree of the operation times of the plurality of execution units in each of the plurality of segmentation methods comprises:
calculating a standard deviation of the operation times of the plurality of execution units according to the operation times of the plurality of execution unit and the average operation time; and
determining the discrete degree according to the standard deviation, the standard deviation being proportional to the discrete degree of the operation times of the plurality of execution units.
